(19) United States
(12) Patent Application Publication
(10) Pub. No.: US 2025/0154724 A1
(43) Pub. Date: May 15, 2025

(54) METHOD FOR PRODUCING LAMINATE AND METHOD FOR PRODUCING MOLDED ARTICLE

(71) Applicant: KANEKA CORPORATION, Osaka-shi (JP)

(72) Inventors: Itsuki KUSAKABE, Settsu-shi (JP); Yasunori OKADA, Settsu-shi (JP)

(73) Assignee: KANEKA CORPORATION, Osaka-shi (JP)

(21) Appl. No.: 19/019,659

(22) Filed: Jan. 14, 2025

Related U.S. Application Data
(63) Continuation of application No. PCT/JP2023/025668, filed on Jul. 12, 2023.

(30) Foreign Application Priority Data
Jul. 29, 2022 (JP) 2022-121323

(51) Int. Cl. D21H 19/28; B65D 65/42; D21H 25/06

(52) U.S. Cl. CPC D21H 19/28; B65D 65/42; D21H 25/06

(57) ABSTRACT

A method of forming a laminated article that includes a substrate and a resin layer. The method includes forming a coating on a substrate by applying an aqueous dispersion of a poly(hydroxyalkanoate) resin to the substrate. Subsequently, the resin layer is formed by fusing the poly(hydroxyalkanoate) resin by heating the coating. The coating can be heated using superheated steam to a surface temperature 10 to 100° C. above a melting point (Tm) of the poly(hydroxyalkanoate) resin.

### TECHNICAL FIELD

The present invention relates to a method for producing a laminate including a resin layer containing a poly(hydroxyalkanoate) resin and a method for producing a molded article including the laminate.

### BACKGROUND ART

In recent years, environmental problems due to waste plastics have become an issue of great concern. In particular, waste plastics have caused serious marine pollution, and there is a demand for widespread use of biodegradable plastics which are degradable in the natural environment.

Various kinds of such biodegradable plastics are known. Poly(3-hydroxybutyrate) resins, which are a class of poly(hydroxyalkanoate) resins, are thermoplastic polyesters produced and accumulated as energy storage substances in the cells of many kinds of microorganisms, and these resins are biodegradable in seawater as well as in soil and thus are attracting attention as materials that can be a solution to the above-mentioned problems.

A laminate including a biodegradable paper substrate and a layer located on the paper substrate and containing a poly(hydroxyalkanoate) resin such as a poly(3-hydroxybutyrate) resin as a main component is very promising in terms of environmental protection because both the resin and the substrate have high biodegradability.

An example of a method for producing such a laminate is described in Patent Literature 1. In the method of Patent Literature 1, an aqueous dispersion containing a copolymer of 3-hydroxybutyrate and 3-hydroxyhexanoate which has a given average molecular weight is applied to a substrate, and then the applied dispersion is heated and dried to form a layer on the substrate.

### CITATION LIST

### Patent Literature

PTL 1: WO 2021/075412

### SUMMARY OF INVENTION

### Technical Problem

The method as described in Patent Literature 1, in which an aqueous resin dispersion is applied to a substrate, can produce a laminate including the substrate and a resin layer located on the substrate and containing a poly(hydroxyalkanoate) resin as a main component.

However, electron microscopy of a cross-section of the resin layer of the laminate obtained by the method described in Patent Literature 1 has revealed that the resin layer could have a particulate resin portion or a void and lack sufficient uniformity. The particulate portion or void remaining in the resin layer could cause a decline in the adhesion of the resin layer to the substrate or in the water resistance or oil resistance to be exhibited by the resin layer.

If the temperature during heating and drying is set high, the poly(hydroxyalkanoate) resin could suffer from a significant loss in molecular weight. The loss in molecular weight of the resin could lead to a failure to achieve desired physical properties or could increase the occurrence of cracks in the resin layer.

In view of the above circumstances, the present invention aims to provide a method for producing a laminate by applying an aqueous dispersion of a poly(hydroxyalkanoate) resin to a substrate, the method being adapted to improve the uniformity of the resin layer without any significant loss in the molecular weight of the resin.

### Solution to Problem

As a result of intensive studies with the goal of solving the above problem, the present inventors have found that the problem can be solved by applying an aqueous dispersion of a poly(hydroxyalkanoate) resin to a substrate and subsequently heating a coating of the applied aqueous dispersion by means of superheated steam to a temperature in a given range so as to fuse the resin in the coating. Based on this finding, the inventors have completed the present invention.

Specifically, the present invention relates to a method for producing a laminate including a substrate and a resin layer formed on at least one side of the substrate, the method including the steps of: forming a coating on the substrate by applying an aqueous dispersion of a poly(hydroxyalkanoate) resin to the substrate; and forming the resin layer by fusing the poly(hydroxyalkanoate) resin through heating of the coating, wherein the coating is heated using superheated steam to a surface temperature 10 to 100° C. above a melting point (Tm) of the poly(hydroxyalkanoate) resin.

### Advantageous Effects of Invention

The present invention can provide a method for producing a laminate by applying an aqueous dispersion of a poly(hydroxyalkanoate) resin to a substrate, the method being adapted to improve the uniformity of the resin layer without any significant loss in the molecular weight of the resin.

Furthermore, the present invention can prevent heating-induced defects including curling of the laminate, loss in tearing resistance of the laminate, and discoloration of the substrate.

### DESCRIPTION OF EMBODIMENTS

Hereinafter, embodiments of the present invention will be described. The present invention is not limited to the embodiments described below.

A production method according to one embodiment of the present disclosure is a method for producing a laminate. The laminate includes at least a substrate and a resin layer formed on one or both sides of the substrate. In a preferred aspect, the laminate can exhibit biodegradability as a whole.

The resin layer may be located directly on the substrate or may be located over the substrate with another layer interposed between the resin layer and the substrate. Preferably, the resin layer is located directly on the substrate.

In one aspect of the present disclosure, the resin layer may be an outermost layer of the laminate. In this case, the resin layer can function, for example, as a heat-sealable layer, a water-resistant layer, and/or an oil-resistant layer.

In another aspect of the present disclosure, another layer may be located on the resin layer. In this case, the resin layer can function as an anchor coat layer between the substrate and the other layer. The other layer is not limited to a particular type and may be another resin layer or an inorganic layer. An example of the other layer is a second resin layer described later.

The substrate may be an outermost layer carrying no layer on the side opposite to that on which the resin layer is located, or a layer may be located on the opposite side of the substrate. The layer may be a layer corresponding to the resin layer or may be a layer other than the first resin layer.

### (Substrate)

The material of the substrate is not limited to a particular type but is desirably biodegradable. Examples of the substrate include a layer of paper, a layer of cellophane, a layer of cellulose ester, a layer of polyvinyl alcohol, a layer of polyamino acid, a layer of polyglycolic acid, a layer of pullulan, and any of these layers on which an inorganic substance such as aluminum or silica is vapor-deposited. A layer of paper is preferred because it has high heat resistance and is inexpensive.

The paper is a sheet made primarily of pulp. The paper substrate can be obtained by a papermaking process using a papermaking material containing pulp mixed with a loading material and various auxiliary agents.

Paper that can be used as the paper substrate is not limited to a particular type, and examples include cup paper, kraft paper, high-quality paper, coated paper, tissue paper, glassine paper, and paperboard.

Examples of the pulp include, but are not limited to: chemical pulp such as leaf bleached kraft pulp (LBKP), needle bleached kraft pulp (NBKP), leaf unbleached kraft pulp (LUKP), needle unbleached kraft pulp ((NUKP), and sulfite pulp; mechanical pulp such as stone-ground pulp and thermomechanical pulp; wood fibers such as deinked pulp and waste paper pulp; and non-wood fibers such as those obtained from kenaf, bamboo, and hemp. Any of these types of pulp may be used in any proportion as appropriate.

Among the above examples, chemical or mechanical pulp derived from wood fibers is preferably used, and chemical pulp derived from wood fibers is more preferably used. This is because, for example, the use of such pulp offers the following advantages: foreign matter does not readily enter the paper; the paper resists discoloration over time when recycled as a waste paper material; and the paper has a high degree of whiteness and hence presents a surface appearance suitable for printing, thus enhancing the utility of the laminate for use, in particular, as a packaging material. Specifically, the amount of chemical pulp such as LBKP or NBKP in the total pulp is preferably 80% or more and particularly preferably 100%.

Examples of the loading material include, but are not limited to: inorganic loading materials such as talc, kaolin, calcined kaolin, clay, ground calcium carbonate, precipitated calcium carbonate, white carbon, zeolite, magnesium carbonate, barium carbonate, titanium dioxide, zinc oxide, silicon oxide, amorphous silica, aluminum hydroxide, calcium hydroxide, magnesium hydroxide, zinc hydroxide, barium sulfate, and calcium sulfate; and organic loading materials such as a urea-formalin resin, a polystyrene resin, a phenolic resin, and microballoons. The loading material is not an essential material and need not be used.

Examples of the various auxiliary agents include, but are not limited to: sizing agents such as rosin, an alkyl ketene dimer (AKD), and an alkenyl succinic anhydride (ASA); dry paper strengthening agents such as a polyacrylamide polymer, a polyvinyl alcohol polymer, cationic starch, various types of modified starch, a urea-formalin resin, and a melamine-formalin resin; wet paper strengthening agents; retention aids; filterability improvers; coagulants; aluminum sulfate; bulking agents; dyes; fluorescent brighteners; pH adjusters; anti-foaming agents; ultraviolet protective agents; anti-fading agents; pitch control agents; and slime control agents. Any of these auxiliary agents may be selected and used as necessary.

The surface of the paper may be treated with any of various chemicals. Examples of the chemicals include, but are not limited to, oxidized starch, hydroxyethyl etherified starch, enzyme-modified starch, polyacrylamide, polyvinyl alcohol, a surface sizing agent, a waterproofing agent, a water retention agent, a thickener, and a lubricant. One chemical may be used alone or two or more chemicals may be used in combination. These chemicals may be used in combination with a pigment.

Examples of the pigment include, but are not limited to: inorganic pigments such as kaolin, clay, engineered kaolin, delaminated clay, ground calcium carbonate, precipitated calcium carbonate, mica, talc, titanium dioxide, barium sulfate, calcium sulfate, zinc oxide, silicic acid, silicate salt, colloidal silica, and satin white; and organic pigments such as solid, hollow, and core-shell pigments. One pigment may be used alone or two or more pigments may be used in combination.

The weight per square meter of the substrate, in particular the paper substrate, can be selected as appropriate depending on factors such as the desired quality of the substrate and the intended use of the laminate. The weight per square meter of the substrate is preferably from 40 to 400 g/m² and more preferably from 50 to 350 g/m². When the laminate is used as wrapping paper, a paper bag, a lidding material, a paper mat, a packaging material such as a soft packaging material, or a poster for outdoor use, the weight per square meter of the substrate is even more preferably from 40 to 150 g/m². The term “soft packaging material” refers to a flexible packaging material made with thin paper having a weight per square meter of about 40 to about 100 g/m². When the laminate is used as a piece of paper tableware such as a paper cup, a paper box, a paper plate, or a paper tray, as a lidding material, or as any other kind of paper container, the weight per square meter of the substrate is even more preferably from 150 to 400 g/m².

The density of the substrate, in particular the paper substrate, can be selected as appropriate depending on factors such as the desired quality and handleability of the substrate. In general, the density of the substrate is preferably from 0.5 to 1.0 g/cm³.

The production of the substrate is not limited to using a particular method. The production of the paper substrate (papermaking) is not limited to using a particular method either and can be accomplished by any means selected as appropriate from known papermaking machines such as a Fourdrinier machine, a cylinder machine, a short wire machine, and a twin-wire machine such as a gap former machine or hybrid former (on-top former) machine. The pH in the papermaking may be in an acidic region (acidic papermaking), a quasi-neutral region (quasi-neutral papermaking), a neutral region (neutral papermaking), or an alkaline region (alkaline papermaking). After the papermaking is performed in an acidic region, the surface of the paper layer may be coated with an alkaline chemical. The paper substrate may consist of a single layer or may be a multilayer substrate made up of two or more layers.

When the surface of the paper substrate is treated with a chemical, the surface treatment is not limited to using a particular method and can be performed by means of any known coating device such as a rod metering size press, a pond size press, a gate roll coater, a spray coater, a blade coater, or a curtain coater.

### (Resin Layer)

The resin layer formed on at least one side of the substrate contains at least a poly(hydroxyalkanoate) resin (hereinafter also referred to as a “PHA”). One PHA may be used alone or two or more PHAs may be used in combination. The resin layer may contain only a PHA as a resin component or may further contain another resin. The other resin used may be a biodegradable resin as described later.

The term “poly(hydroxyalkanoate) resin” generically refers to a polymer containing hydroxyalkanoic acid as a monomer unit. Examples of hydroxyalkanoic acids constituting PHAs include, but are not limited to, 3-hydroxybutyric acid, 4-hydroxybutyric acid, 3-hydroxypropionic acid, 3-hydroxypentanoic acid, 3-hydroxyhexanoic acid, 3-hydroxyheptanoic acid, and 3-hydroxyoctanoic acid. The PHA used may be a homopolymer or a copolymer containing two or more types of monomer units.

The resin layer preferably contains 50 wt % or more, more preferably 70 wt % or more, even more preferably 80 wt % or more, still even more preferably 90 wt % or more, of a PHA. The resin layer containing a PHA as a main component can exhibit biodegradability.

The PHA is preferably a poly(3-hydroxybutyrate) resin (hereinafter also referred to as a “P3HB”).

The term “P3HB “refers to a homopolymer containing only 3-hydroxybutyrate units and/or a copolymer containing 3-hydroxybutyrate units and other hydroxyalkanoate units. In terms of biodegradability in seawater, the resin layer preferably contains a copolymer containing 3-hydroxybutyrate units and other hydroxyalkanoate units.

The copolymerization that gives the copolymer is not limited to a particular type and may be random copolymerization, alternating copolymerization, block copolymerization, or graft copolymerization. A microbially produced copolymer is usually a random copolymer.

Examples of hydroxyalkanoic acids forming the other hydroxyalkanoate units include, but are not limited to, 4-hydroxybutyric acid, 3-hydroxypropionic acid, 3-hydroxypentanoic acid, 3-hydroxyhexanoic acid, 3-hydroxyheptanoic acid, and 3-hydroxyoctanoic acid.

Specific examples of P3HBs include poly(3-hydroxybutyrate) abbreviated as “PHB”, poly(3-hydroxybutyrate-co-3-hydroxyhexanoate) abbreviated as “PHBH”, poly(3-hydroxybutyrate-co-3-hydroxyvalerate) abbreviated as “P3HB3HV”, poly(3-hydroxybutyrate-co-4-hydroxybutyrate) abbreviated as “P3HB4HB”, poly(3-hydroxybutyrate-co-3-hydroxyoctanoate) abbreviated as “P3HB3HO”, poly(3-hydroxybutyrate-co-3-hydroxyoctadecanoate) abbreviated as “P3HB3HOD”, poly(3-hydroxybutyrate-co-3-hydroxydecanoate) abbreviated as “P3HB3HD”, and poly(3-hydroxybutyrate-co-3-hydroxyvalerate-co-3-hydroxyhexanoate) abbreviated as “P3HB3HV3HH”. Among these, PHB, PHBH, P3HB3HV, and P3HB4HB are preferred since they are easy to industrially produce. One P3HB may be used alone or two or more P3HBs may be used in combination.

The resin layer preferably contains 50 wt % or more, more preferably 70 wt % or more, even more preferably 80 wt % or more, still even more preferably 90 wt % or more, of a P3HB. The resin layer containing a P3HB as a main component can exhibit biodegradability.

Among P3HBs, PHBH is particularly preferred for the following reasons: its melting point and crystallinity can be changed by varying the proportions of the repeating units, and thus its physical properties such as Young's modulus and heat resistance can be adjusted and controlled to levels intermediate between those of polypropylene and polyethylene; and PHBH is a plastic that is easy to industrially produce and useful in terms of physical properties.

The resin layer preferably contains 50 wt % or more, more preferably 70 wt % or more, even more preferably 80 wt % or more, still even more preferably 90 wt % or more, of PHBH. The resin layer containing PHBH as a main component can exhibit biodegradability, in particular biodegradability in seawater.

The average content ratio between different monomer units in the P3HB used (3HB units/other hydroxyalkanoate units) is preferably from 97 to 70/3 to 30 (mol %/mol %) and more preferably from 94 to 82/6 to 18 (mol %/mol %). When the average content of the other hydroxyalkanoate units in the P3HB is 3 mol % or more, heat sealing using the resin layer can achieve good bond performance. When the average content of the other hydroxyalkanoate units is 30 mol % or less, the crystallization rate of the P3HB is not too low, and the production of the P3HB is relatively easy.

When the P3HB includes PHBH and has an average 3HH content of 3 to 30 mol %, the P3HB may consist only of one type of PHBH or may be a mixture of at least two types of PHBH differing in the contents of the constituent monomers or a mixture of at least one type of PHBH and PHB.

The combination of different types of PHBH or the combination of PHBH and PHB in the mixture is preferably a combination of PHBH having a 3HH unit content of 8 to 25 mol % and PHBH having a 3HH unit content of less than 8 mol % or a combination of PHBH having a 3HH unit content of 8 to 25 mol % and PHB. With the use of such a combination, even when heat sealing using the resin layer is performed at an elevated temperature high enough to ensure bonding of the resin layer, satisfactory bond strength can be exhibited in a short time after the heat sealing.

In the above combination, the content of 3HH units in the PHBH having a 3HH unit content of less than 8 mol % is preferably 5 mol % or less, more preferably 3 mol % or less, and even more preferably 1 mol % or less. The lower limit of the 3HH unit content in the PHBH is not limited to a particular value, and the 3HH unit content may be, for example, 0.1 mol % or more.

The amount of the PHBH having a 3HH unit content of less than 8 mol % or the PHB is not limited to a particular range but is preferably from 0 to 50 wt % based on the total amount of the P3HB resins contained in the resin layer. When the resin layer contains the PHBH or PHB, the amount of the PHBH or PHB is preferably from 1 to 50 wt %, more preferably from 3 to 30 wt %, even more preferably from 4 to 20 wt %, and particularly preferably from 5 to 15 wt %.

The average content ratio between different monomer units in a P3HB can be determined by a method known to those skilled in the art, such as a method described in paragraph [0047] of WO 2013/147139 or by NMR analysis. The average content ratio refers to the molar ratio between 3HB units and other hydroxyalkanoate units in the total P3HB contained in the resin layer. When the P3HB is a mixture containing at least two types of PHBH or a mixture containing at least one type of PHBH and PHB, the average content ratio refers to the molar ratio between different monomer units contained in the total mixture.

The weight-average molecular weight (hereinafter also referred to as “Mw”) of a PHA contained in the resin layer can be selected as appropriate. In terms of ensuring both good mechanical properties and high processability, the weight-average molecular weight is preferably from 5×10⁴ to 90×10⁴, more preferably from 10×10⁴ to 80×10⁴, and even more preferably from 15×10⁴ to 70×10⁴. The use of a P3HB having a weight-average molecular weight of 5×10⁴ or more can result in good mechanical properties. The use of a P3HB having a weight-average molecular weight of 90×10⁴ or less makes it possible to achieve high bond performance in heat sealing.

The weight-average molecular weight of the PHA as described above can be determined as a polystyrene-equivalent molecular weight measured by gel permeation chromatography (GPC; “Shodex GPC-101” manufactured by Showa Denko K.K.) using a polystyrene gel (“Shodex K-804” manufactured by Showa Denko K.K.) as a column and chloroform as a mobile phase.

A specific method for producing PHBH is described, for example, in WO 2010/013483. Examples of commercially-available PHBH include “Kaneka Biodegradable Polymer Green Planet™” of Kaneka Corporation.

The resin layer may contain one or two or more of the following components to the extent that the contained components do not diminish the effect of the invention: a resin other than PHAs; an adhesive; a dispersant or an emulsifier; a pH adjuster; an inorganic filler; a colorant such as a pigment or dye; an odor absorber such as activated carbon or zeolite; a flavor such as vanillin or dextrin; a plasticizer; an oxidation inhibitor; an antioxidant; a weathering resistance improver; an ultraviolet absorber; a nucleating agent; a lubricant; a mold release; a water repellent; an antimicrobial; and a slidability improver. These components are optional components, and the resin layer need not contain these components.

The resin other than PHAs and usable in the resin layer is not limited to a particular type but is preferably a biodegradable resin. Specific examples of such a resin include: aliphatic polyester resins such as polycaprolactone, polybutylene succinate adipate, polybutylene succinate, and polylactic acid; and aliphatic-aromatic polyester resins such as polybutylene adipate terephthalate and polybutylene azelate terephthalate. The amount of the resin other than PHAs may be 50 parts by weight or less, 30 parts by weight or less, or 10 parts by weight or less, per 100 parts by weight of the PHA contained in the resin layer. The amount of the other resin may be 5 parts by weight or less or 1 part by weight or less.

The thickness of the resin layer is not limited to a particular range and can be chosen as appropriate in view of factors such as the performance required of the resin layer and the productivity. For example, the thickness of the resin layer may be from 0.5 to 100 μm and may be from 1 to 30 μm.

### (Coating Formation Step)

In the production method according to the present embodiment, first, an aqueous dispersion of a PHA is prepared, and the aqueous dispersion is applied to one side or both sides of a substrate to form a coating on the substrate.

The term “aqueous dispersion of a PHA” refers to a liquid containing at least PHA-containing resin particles dispersed in water. If necessary, the aqueous dispersion may further contain a dissolved or dispersed component other than the resin particles. The application of the aqueous dispersion as a coating liquid to the substrate offers the following advantage, especially when a resin layer is directly formed on a paper substrate without any other layer interposed between the resin layer and the paper substrate: a portion of the coating liquid infiltrates the paper substrate, and this infiltration is likely to further enhance the adhesion of the resin layer to the paper substrate.

The aqueous dispersion can be prepared, for example, with reference to WO 2021/059592.

The solids concentration of the PHA in the aqueous dispersion may be set as appropriate. The solids concentration of the PHA may be, for example, from 25 to 65 wt % and is preferably from 30 to 55 wt % and more preferably from 35 to 50 wt %. When the solids concentration of the PHA in the aqueous dispersion is in the above range, the dispersion has a moderate viscosity and can be applied uniformly. Additionally, the coating can maintain a required thickness and thus avoid having defects.

In terms of ensuring both high PHA productivity and uniform application of the aqueous dispersion, the average particle size of the PHA particles in the aqueous dispersion may be, for example, from 0.1 to 50 μm and is preferably from 0.5 to 30 μm and more preferably from 0.8 to 20 μm. When the average particle size is 0.1 μm or more, the PHA can easily be obtained either by microbial production or by chemical synthesis. When the average particle size is 50 μm or less, uneven application of the aqueous dispersion can be avoided. The average particle size of the PHA particles in the aqueous dispersion can be measured by adjusting an aqueous suspension containing the PHA to a given concentration and subjecting the suspension to analysis using a widely used particle size analyzer such as Microtrac particle size analyzer (FRA manufactured by Nikkiso Co., Ltd.). The average particle size can be determined as a particle size at which the cumulative percentage in a normal distribution curve reaches 50% of all the particles.

The aqueous dispersion need not contain any emulsifier but preferably contains an emulsifier to stabilize the dispersion. Examples of the emulsifier include: anionic surfactants such as sodium lauryl sulfate and sodium oleate; cationic surfactants such as lauryl trimethyl ammonium chloride; non-ionic surfactants such as glycerin fatty acid esters and sorbitan fatty acid esters; polyvinyl alcohol; polyvinyl alcohol derivatives such as carboxy-modified polyvinyl alcohol, sulfone-modified polyvinyl alcohol, and ethylene-modified polyvinyl alcohol; cellulose derivatives such as methyl cellulose, carboxymethyl cellulose, hydroxyethyl cellulose, and hydroxypropyl cellulose; starch; starch derivatives such as oxidized starch and etherified starch; and water-soluble polymers such as chitin, chitosan, casein, and gum arabic. One of these emulsifiers may be used alone, or two or more thereof may be used in combination. Among the above-mentioned emulsifiers, polyvinyl alcohol is preferred since an aqueous polyvinyl alcohol solution can easily be prepared for addition to the dispersion on an industrial scale.

The amount of the emulsifier to be added is not limited to a particular range but is preferably from 1 to 10 wt % based on the amount of the solids of the PHA. When the amount of the added emulsifier is 1 wt % or more, the addition of the emulsifier is likely to provide a stabilizing effect. When the amount of the added emulsifier is 10 wt % or less, deterioration in physical properties or coloring due to incorporation of an excess amount of the emulsifier into the PHA can be avoided.

The application of the aqueous dispersion to the substrate is not limited to using a particular technique, and any known technique can be used as appropriate. Specifically, a spray method, a spreading method, a slit coater method, an air knife coater method, a roll coater method, a bar coater method, a comma coater method, a blade coater method, a screen printing method, or a gravure printing method can be used.

The application of the aqueous dispersion may be preceded by the step of subjecting the paper substrate to a surface treatment such as corona treatment.

The amount of the PHA to be applied is not limited to a particular range and can be chosen as appropriate in view of factors such the performance required of the resin layer and the productivity. Specifically, the amount of the applied PHA, as expressed as dry weight per square meter, is preferably from 1.0 to 80 g/m², more preferably from 5.0 to 60 g/m², and even more preferably from 10 to 50 g/m². When the amount of the applied PHA is in such a range, the resin layer can be prevented from having defects such as pinholes, can have sufficient strength for practical use, and can effectively exhibit properties such as water resistance and oil resistance.

The amount of the PHA to be applied and the weight per square meter of the substrate described above are preferably set such that the amount (dry weight per square meter) of the applied PHA divided by the weight per square meter of the substrate (the amount of the applied PHA/the weight per square meter of the substrate) is from 0.05 to 0.45. When this requirement is met, the resin layer can effectively exhibit properties such as water resistance and oil resistance, and a laminate can be efficiently produced by the production method according to the present disclosure.

### (Drying Step)

The formation of the coating may be followed by the step of heating and drying the coating, i.e., reducing the water content of the coating, without using superheated steam. The heating temperature in this step is not limited to a particular range and may be lower than the melting point (Tm) of the PHA. Specifically, the heating temperature may be lower than 130° C. and may be up to 125° C. The lower limit of the heating temperature is not limited to a particular temperature. The heating temperature may be, for example, 70° C. or higher and is preferably 90° C. or higher and more preferably 100° C. or higher.

The heating time in the drying step is not limited to a particular range and can be set as appropriate. The heating time may be, for example, from 10 seconds to 10 minutes and is preferably from about 30 seconds to about 5 minutes.

The drying step can be performed using a known heating technique. Examples of the heating technique include hot air heating, infrared heating, ultrasound irradiation, microwave heating, roll heating, and hot plate heating. One of these techniques may be used alone, or two or more thereof may be used in combination.

The drying step need not be performed. That is, the drying step may be skipped, and the coating formation step may be directly followed by a resin layer formation step using superheated steam. This is because the heating using superheated steam can promote drying of the coating.

### (Conditioning Step)

The drying step described above may be followed by a conditioning step of adjusting the moisture content of the dried substrate. The conditioning step can reduce curling of the substrate which occurred in the drying step.

In this step, the moisture content of the substrate is preferably increased by spraying water onto the surface of the substrate. The water sprayed may contain an additive, examples of which include a moisturizer such as glycerin or propylene glycol, any kind of flavor, and a preservative.

The temperature of the water sprayed is not limited to a particular range and may be, for example, from about 10 to about 50° C. The water need not be temperature-conditioned and may be at room temperature (about 10 to about 30° C.).

The amount of the water used may be set as appropriate in view of the moisture content of the substrate having undergone the drying step and the target moisture content of the substrate. The target moisture content of the substrate is not limited to a particular range. The target moisture content may be, for example, from about 5 to about 8% and may be from 6 to 7%.

The conditioning step need not be performed. That is, the conditioning step may be skipped, and the coating formation step or the drying step may be directly followed by a resin layer formation step using superheated steam.

### (Resin Layer Formation Step Using Superheated Steam)

The coating formation step, or the optional drying or conditioning step, is followed by the step of forming a resin layer by fusing the PHA through heating of the coating by means of superheated steam. In this step, at least a portion of the PHA melts first, then the molten portion cools and solidifies after the heating, and thus the PHA can be fused.

Before the coating is heated using superheated steam, the PHA particles contained in the aqueous dispersion are present on the substrate but are not fully bonded to one another; thus, the coating yet to be heated does not have sufficient uniformity. In the resin layer formation step, the coating is heated in a temperature range where at least a portion of the PHA melts. By this heating, the PHA particles can be fused together to form the resin component into a single mass. As a result, a resin layer with improved uniformity can be formed.

The resin layer formation step uses superheated steam as heating means. The term “superheated steam” refers to high-heat-energy steam produced by heating saturated water vapor to a temperature above the saturation temperature.

The use of superheated steam in heating the coating can efficiently improve the uniformity of the resin layer. This is expected to enhance the adhesion of the resin layer to the substrate and improve the reliability with which the resin layer exhibits a required level of water resistance or oil resistance.

If a resin layer is formed using hot air which is common heating means, the PHA particles are not fully fused together, and the resin layer tends to present a cross-section having a particulate portion or a void and lack sufficient uniformity. The resin layer with insufficient uniformity could lack sufficient adhesion to the substrate and lack sufficient water resistance or oil resistance.

Superheated steam has a higher heat capacity than hot air. Thus, superheated steam is less likely to undergo a temperature decrease and can efficiently heat the resin layer to facilitate melting of the PHA.

Furthermore, the heating step using superheated steam causes little damage to the substrate and is advantageous in order to prevent defects including curling of the laminate, loss in tearing resistance of the laminate, and discoloration of the paper substrate, all of which could be caused by the use of common heating means.

The temperature of heating using superheated steam is set such that the coating is heated to a surface temperature 10 to 100° C. above the melting point (Tm) of the PHA (i.e., a temperature in the range of Tm+10° C. to Tm+100° C.). When the surface temperature of the coating is in this temperature range, fusion of the PHA can be allowed to proceed and decomposition of the PHA can be prevented. The surface temperature is preferably 10 to 80° C. above the Tm, more preferably 10 to 70° C. above the Tm, even more preferably 20 to 60° C. above the Tm, and particularly preferably 30 to 50° C. above the Tm.

The melting point (Tm) of the PHA refers to a peak top temperature in a crystalline melting curve obtained by differential scanning calorimetry of the PHA that has yet to be subjected to the resin layer formation step. In the case where there are a plurality of peaks in the crystalline melting curve, the melting point (Tm) of the PHA refers to the lowest of the peak top temperatures.

To control the surface temperature of the coating within the temperature range mentioned above, the temperature of the superheated steam sprayed and other factors such as the amount of the superheated steam sprayed and the heating time (the time for which the superheated steam is sprayed) may be adjusted.

The superheated steam is typically sprayed from a spray nozzle. In the heating step, the superheated steam is preferably sprayed onto the surface of the coating. The superheated steam may be sprayed not only onto the surface of the coating but onto the surface of the substrate on which the coating has not been formed.

The time of heating using superheated steam is not limited to a particular range and may be, for example, from 2 seconds to 10 minutes. The heating time is preferably from 20 seconds to 5 minutes and more preferably from 30 seconds to 2 minutes.

### (Second Conditioning Step)

The heating step using superheated steam may be followed by a second conditioning step of adjusting the moisture content of the substrate. The second conditioning step can reduce curling of the substrate which occurred in the heating step. Additionally, solidification or crystallization of the PHA can be accelerated. The details of the second conditioning step are the same as those of the conditioning step previously described.

The second conditioning step can be skipped or simplified since the heating using superheated steam causes less curling of the laminate.

### (Resin Layer)

In the laminate that can be produced according to the present embodiment, the resin layer can be an outermost layer. In this case, the resin layer can function, for example, as a heat-sealable layer, a water-resistant layer, and/or an oil-resistant layer.

The heat-sealable layer is a layer having properties suitable for heat sealing. Specifically, the heat-sealable layer is a layer that can be bonded to a bonding target by thermal pressure bonding. The bonding target may be another portion of the same heat-sealable layer, may be the substrate, or may be an article made of a different material.

In the laminate that can be produced according to the present embodiment, the resin layer containing a PHA as a main component preferably has melting characteristics which are such that in a crystalline melting curve obtained by differential scanning calorimetry, the resin layer has at least one peak top temperature (Tma) in the range of 100 to 150° C. and at least one peak top temperature (Tmb) in the range of 150 to 170° C. and that the difference between the temperatures Tma and Tmb is 10° C. or more.

The resin layer having such melting characteristics can offer the following advantages: the resin layer can be bonded by heat sealing in molding of the laminate; a wide range of heat sealing temperatures can be used; and satisfactory bond strength can be exhibited in a short time after heating even when the resin is heated to a temperature high enough to ensure the bonding of the resin layer.

When the resin layer has a melting point peak in the relatively high temperature range of 150 to 170° C., a resin crystal having the Tmb acts as a crystal nucleus, which allows the resin melted during heat sealing to solidify so quickly that satisfactory bond strength can be exhibited in a short time after the heat sealing even when the resin is heated to a temperature high enough to ensure the bonding of the resin layer.

The difference between the temperatures Tma and Tmb is more preferably 15° C. or more, even more preferably 20° C. or more, and particularly preferably 25° C. or more. The upper limit of the difference between the temperatures Tma and Tmb is not limited to a particular value. In terms of ease of production, the temperature difference is, for example, 60° C. or less and more preferably 50° C. or less.

In the present specification, peak top temperatures in a crystalline melting curve obtained by differential scanning calorimetry are defined as follows. An aluminum pan is charged with 2 to 5 mg of a resin as the measurement object, and the resin is subjected to differential scanning calorimetry which uses a differential scanning calorimeter and in which the resin is melted under a stream of nitrogen by increasing the temperature from 20 to 190° C. at a rate of 10° C./min. In the crystalline melting curve obtained by the calorimetry, the temperature at which is located the top of a melting point peak present in the range of 100 to 150° C. is defined as the Tma, and the temperature at which is located the top of a melting point peak present in the range of 150 to 170° C. is defined as the Tmb. When a plurality of melting point peaks are observed in the range of 100 to 150° C., the temperature at which is located the top of the highest of the melting point peaks is defined as the Tma. When a plurality of melting point peaks are observed in the range of 150 to 170° C., the temperature at which is located the top of the highest of the melting point peaks is defined as the Tmb.

The laminate including the resin layer that exhibits the melting characteristics as stated above can be produced through the above-described heating step using superheated steam.

### (Second Resin Layer)

A laminate according to another aspect of the present embodiment may further include a second resin layer located on the resin layer described above (referred to as the “first resin layer” in the present aspect). In the present aspect, the substrate, the first resin layer, and the second resin layer are arranged in this order.

In the present aspect, the first resin layer functions as an anchor coat layer between the substrate and the second resin layer. The presence of the second resin layer can impart a high level of water resistance and oil resistance to the laminate.

In this aspect, the first resin layer has an ability to ensure bonding between the paper substrate and the second resin layer. The thickness of the first resin layer may be from 0.5 to 100 μm as stated above, but is preferably from 0.7 to 15 μm and more preferably from 1 to 10 μm.

The second resin layer may be an outermost layer of the laminate, or the laminate may further include another layer located on the second resin layer.

Preferably, the second resin layer contains a biodegradable resin and exhibits biodegradability. In this case, the biodegradability of the laminate as a whole can be enhanced. Biodegradable resins that can be used include resins as mentioned above for the first resin layer, and specific examples include PHAs, aliphatic polyester resins, and aliphatic-aromatic polyester resins. The second resin layer may contain additives usually added to resin materials, to the extent that the additives do not diminish the effect of the invention.

The thickness of the second resin layer is not limited to a particular range and can be chosen as appropriate in view of factors such as the performance required of the second resin layer and the productivity. For example, the thickness of the second resin layer may be from about 5 to about 100 μm.

Examples of the method for forming the second resin layer on the first resin layer include, but are not limited to, a coating method, an extrusion lamination method, and a thermal lamination method.

### [Molded Article]

The laminate that can be produced according to the present embodiment can be molded into a molded article (hereinafter also referred to as the “present molded article”) having a given shape. The molded article includes the laminate and has a desired size and shape. Being made with the laminate including the resin layer containing a PHA, the present molded article is advantageous for various uses.

The present molded article is not limited to a particular product and may be any product including the present laminate. Examples of the present molded article include paper, a film, a sheet, a tube, a plate, a rod, a container (e.g., a bottle), a bag, and a part. In terms of addressing marine pollution, the present molded article is preferably a packaging bag, a lidding material, or a container such as a cup or tray.

In one embodiment of the present disclosure, the present molded article may be the present laminate itself or may be one produced by secondary processing of the present laminate.

The present molded article including the present laminate subjected to secondary processing is suitable for use as any of various kinds of packaging materials or containers such as shopping bags, various other kinds of bags, packaging materials for foods or confectionery products, cups, trays, and cartons. That is, the present molded article is suitable for use in various fields such as food industry, cosmetic industry, electronic industry, medical industry, and pharmaceutical industry. Since the present laminate contains a resin having high adhesion to the substrate and having good heat resistance, the present molded article is more preferably used as a container for a hot substance. Examples of such a container include: liquid containers such as, in particular, cups for foods or beverages such as instant noodles, instant soups, and coffee; and trays used for prepared foods, boxed lunches, or microwavable foods.

The secondary processing as described above can be performed using a method identical to that used for secondary processing of conventional resin-laminated paper or coated paper. That is, the secondary processing can be performed by means such as any kind of bag-making machine or form-fill-seal machine. Alternatively, the present laminate may be processed using a device such as a paper cup molding machine, a punching machine, or a case former. In any of these processing machines, any known technique can be used for bonding of the present laminate. Examples of the technique that can be used include heat sealing, impulse sealing, ultrasonic sealing, high-frequency sealing, hot air sealing, and flame sealing.

The heat sealing temperature at which the present laminate is heat-sealed depends on the bonding technique used. For example, in the case where the present laminate is heat-sealed using a heat sealing tester equipped with a sealing bar, the heat sealing temperature may be set so that the surface temperature of the resin layer is typically 180° C. or lower, preferably 170° C. or lower, and more preferably 160° C. or lower. When the surface temperature of the resin layer is in this range, melting and leakage of the resin in the vicinity of the sealed portion can be avoided to ensure a suitable thickness of the resin layer and a suitable seal strength. The surface temperature may be 150° C. or lower or may be 140° C. or lower since the present laminate can exhibit good bonding performance even when heat-sealed at a low temperature. In the case of using a heat sealing tester equipped with a sealing bar, the surface temperature is typically at least 100° C., preferably at least 110° C., and more preferably at least 120° C. When the surface temperature is in this range, suitable bonding can be ensured at the sealed portion.

The heat sealing pressure at which the present laminate is heat-sealed depends on the bonding technique used. For example, in the case where the present laminate is heat-sealed using a heat sealing tester equipped with a sealing bar, the heat sealing pressure is typically 0.1 MPa or more and preferably 0.5 MPa or more. When the heat sealing pressure is in this range, suitable bonding can be ensured at the sealed portion. In the case of using a heat sealing tester equipped with a sealing bar, the heat sealing pressure is typically up to 1.0 MPa and preferably up to 0.75 MPa. When the heat sealing pressure is in this range, thinning of the sealed edge can be avoided to ensure a suitable seal strength.

The present molded article may, for the purpose of physical property improvement, be combined with another molded article (such as a fiber, a yarn, a rope, a woven fabric, a knit, a non-woven fabric, paper, a film, a sheet, a tube, a plate, a rod, a container, a bag, a part, or a foam) made of a different material than the present molded article. The material of the other molded article is also preferably biodegradable.

In the following items, preferred aspects of the present disclosure are listed. The present invention is not limited to the following items.

### [Item 1]

A method for producing a laminate including a substrate and a resin layer formed on at least one side of the substrate, the method including the steps of:
forming a coating on the substrate by applying an aqueous dispersion of a poly(hydroxyalkanoate) resin to the substrate; and
forming the resin layer by fusing the poly(hydroxyalkanoate) resin through heating of the coating, wherein the coating is heated using superheated steam to a surface temperature 10 to 100° C. above a melting point (Tm) of the poly(hydroxyalkanoate) resin.

### [Item 2]

The method according to item 1, wherein the substrate is paper.

### [Item 3]

The method according to item 1 or 2, wherein
an amount (a dry weight per square meter) of the applied poly(hydroxyalkanoate) resin divided by a weight per square meter of the substrate (the amount of the applied poly(hydroxyalkanoate) resin/the weight per square meter of the substrate) is from 0.05 to 0.45.

### [Item 4]

The method according to any one of items 1 to 3, wherein
the amount (the dry weight per square meter) of the applied poly(hydroxyalkanoate) resin is from 1.0 to 80 g/m².

### [Item 5]

The method according to any one of items 1 to 4, wherein
the weight per square meter of the substrate is from 40 to 400 g/m².

### [Item 6]

The method according to any one of items 1 to 5, wherein
the poly(hydroxyalkanoate) resin is a poly(3-hydroxybutyrate) resin.

### [Item 7]

The method according to item 6, wherein
the poly(3-hydroxybutyrate) resin includes a copolymer of 3-hydroxybutyrate units and other hydroxyalkanoate units.

### [Item 8]

The method according to item 7, wherein
an average content of the 3-hydroxybutyrate units in the poly(3-hydroxybutyrate) resin is from 70 to 97 mol %.

### [Item 9]

The method according to item 7, wherein
the other hydroxyalkanoate units are 3-hydroxyhexanoate units.

### [Item 10]

The method according to any one of items 1 to 9, further including the step of drying the coating by heating the coating at a temperature lower than the melting point (Tm) of the poly(hydroxyalkanoate) resin before the step of forming the resin layer.

### [Item 11]

The method according to item 10, further including the step of adjusting a moisture content of the substrate before the step of forming the resin layer and after the step of drying the coating.

### [Item 12]

The method according to any one of items 1 to 11, further including the step of adjusting a moisture content of the substrate after the step of forming the resin layer.

### [Item 13]

The method according to any one of items 1 to 12, wherein
in a crystalline melting curve obtained by differential scanning calorimetry of the resin layer, the resin layer has at least one peak top temperature (Tma) in a range of 100 to 150° C. and at least one peak top temperature (Tmb) in a range of 150 to 170° C., and
a difference between the temperatures Tma and Tmb is 10° C. or more.

### [Item 14]

A method for producing a molded article, the method including the steps of:
producing a laminate by the method according to any one of items 1 to 13; and
molding the laminate into the molded article.

### [Item 15]

The method according to item 14, wherein
the molded article is a packaging bag, a lidding material, or a container.

### EXAMPLES

Hereinafter, the present invention will be specifically described based on examples. The technical scope of the present invention is not limited by the examples given below.

(Preparation of Aqueous Suspension Containing PHBH Separated from Microorganism)

First, Ralstonia eutropha incorporating a 3-hydroxyalkanoate copolymer synthase gene derived from Aeromonas caviae (this transformed microorganism is formerly known as Alcaligenes eutrophus AC32, deposit number: FERM BP-6038) was cultured by a method as taught in J. Bacteriol., 179, pp. 4821-4830 (1997) to obtain microbial cells containing about 67 wt % of PHBH. In the PHBH, the content ratio between repeating units (3-hydroxybutyrate units/3-hydroxyhexanoate units) was 89/11 (mol/mol).

Subsequently, the culture fluid was centrifuged (5000 rpm, 10 min) to separate the microbial cells in the form of a paste from the culture fluid. Water was added to the microbial cells to prepare a suspension containing 75 g dry weight/L of the microbial cells. The microbial cells in the suspension were stirred and physically disrupted to solubilize cellular components other than the PHBH while the suspension was maintained at a pH of 11.7 by adding an aqueous solution of sodium hydroxide as an alkali to the suspension. The solubilization was followed by centrifugation (3000 rpm, 10 min) to obtain a precipitate. The precipitate was washed with water to separate PHBH having a weight-average molecular weight of about 26×10⁴, a 3HH molar fraction of 11%, and a purity of 91%, and a suspension containing 75 g/L of the PHBH was obtained.

The suspension was poured into a stirring vessel equipped with a pH electrode and was held at 70° C. The pH electrode was connected to Labo-controller MDL-6C manufactured by B.E. Marubishi Co., Ltd., and settings were made such that once the pH of the suspension decreased below a preset value, a peristaltic pump was operated to add an aqueous solution of sodium hydroxide to the suspension until the pH reached the preset value. The pH value in the Labo-controller was set to 10, and a 30% hydrogen peroxide solution was added to the suspension such that the hydrogen peroxide concentration was 5 wt % based on the weight of the polymer (0.375 wt % based on the weight of the suspension). After the addition of the hydrogen peroxide solution, the suspension was stirred for 1 hour. Subsequently, the suspension was subjected to centrifugation, which was followed by two times of washing with water and then two times of washing with methanol. A 30% hydrogen peroxide solution was further added as a preservative such that the hydrogen peroxide concentration was 0.1 wt % based on the weight of solids (PHBH) in the aqueous suspension. As a result of these procedures, an aqueous suspension having a PHBH concentration of 52 wt % was obtained. In the aqueous suspension, the protein content was 1,500 ppm in solids, and the PHBH purity was 99.8 wt % or more.

### Example 1

The aqueous PHBH suspension was applied to a paper substrate (weight per square meter=220 g/m²) in an amount (dry weight per square meter) of 35 to 40 g/m², and then the paper substrate coated with the suspension was dried in a hot air drying oven at 120° C. for 60 seconds. A non-reversible temperature label (Thermolabel 5E-125, 5E-170 manufactured by NiGK Corporation) was attached to the surface of the dried coating.

The dried paper surface (the surface facing away from the coating) was misted with water and then wiped with a waste cloth to adjust the moisture content of the paper substrate to 6 to 7% and reduce the curling of the paper substrate.

After the moisture content adjustment and the curling reduction, the laminate was allowed to stand in a box-shaped container, and the coating was heated by spraying superheated steam onto the coating for 60 seconds. The heating by superheated steam spraying was such that the non-reversible temperature label indicated a temperature 30° C. above a resin melting point (Tm). Thus, the PHBH was fused to obtain a laminate having a resin layer formed on the paper substrate.

The resin melting point (Tm) refers to a peak top temperature in a crystalline melting curve obtained by differential scanning calorimetry of the PHBH contained in the aqueous PHBH suspension. In the case where there are a plurality of peaks in the crystalline melting curve, the resin melting point (Tm) refers to the lowest of the peak top temperatures. In this example, the resin melting point (Tm) was 110° C.

### Example 2

A laminate was obtained in the same manner as in Example 1, except that the superheated steam spraying was such that the non-reversible temperature label indicated a temperature 40° C. above the resin melting point.

### Example 3

A laminate was obtained in the same manner as in Example 1, except that the superheated steam spraying was such that the non-reversible temperature label indicated a temperature 60° C. above the resin melting point.

### Example 4

A laminate was obtained in the same manner as in Example 1, except that the superheated steam spraying was such that the non-reversible temperature label indicated a temperature 70° C. above the resin melting point.

### Comparative Example 1

A laminate was obtained in the same manner as in Example 1, except that the superheated steam spraying was such that the non-reversible temperature label indicated a temperature 120° C. above the resin melting point.

### Comparative Example 2

After moisture content adjustment and curling reduction were performed in the same manner as in Example 1, the coating was heated and dried in a hot air oven for 120 seconds instead of being heated by superheated steam spraying. Thus, a laminate having a resin layer formed on the paper substrate was obtained. The heating in the hot air oven was such that the non-reversible temperature label indicated a temperature 40° C. above the resin melting point.

### Comparative Example 3

A laminate was obtained in the same manner as in Comparative Example 2, except that the heating in the hot air oven was such that the non-reversible temperature label indicated a temperature 50° C. above the resin melting point.

### Comparative Example 4

A laminate was obtained in the same manner as in Comparative Example 2, except that the heating in the hot air oven was such that the non-reversible temperature label indicated a temperature 60° C. above the resin melting point.

### Comparative Example 5

A laminate was obtained in the same manner as in Comparative Example 2, except that the heating in the hot air oven was such that the non-reversible temperature label indicated a temperature 70° C. above the resin melting point.

The laminates obtained in Examples 1 to 4 and Comparative Examples 1 to 5 were evaluated for quality of particle fusion, curl height, percentage of molecular weight retention after heating, percentage of tearing resistance retention after heating, and color change by the methods described below. The results are listed in Table 1.

### [Quality of Particle Fusion]

Each of the laminates obtained in Examples and Comparative Examples was immersed in liquid nitrogen to cool the laminate below the Tg of the resin. The cooled laminate was cut to expose a cross-section of the resin layer.

The cross-section of the resin layer was observed by means of a scanning electron microscope (SEM) at a magnification of 2000 times. The quality of particle fusion was rated “Poor” when a particulate portion or a void was found in the cross-section, while when any particulate portion or void was not found in the cross-section, the quality of particle fusion was rated “Good”.

### [Curl Height]

Each of the laminates obtained in Examples and Comparative Examples was cut to give a test piece measuring 300 mm in the machine direction and 200 mm in the width direction. The test piece with the resin layer facing upward was placed on a flat surface, and the maximum distance from the flat surface to the edge of the test piece was determined as the curl height.

### [Percentage of Molecular Weight Retention After Heating]

For each of Examples and Comparative Examples, a laminate for evaluation was obtained in the same manner as the laminate of the corresponding Example or Comparative Example, except that the aqueous PHBH suspension was applied to a 38-km-thick PET film rather than to the paper substrate.

The resin layer was peeled from the laminate for evaluation, and the resin piece obtained was subjected to measurement of weight-average molecular weight (weight-average molecular weight after heating).

Additionally, the coating was peeled from the laminate for evaluation before the heating using superheated steam or a hot air oven, and the coating obtained was subjected to measurement of weight-average molecular weight (weight-average molecular weight before heating).

The weight-average molecular weight was determined as a polystyrene-equivalent molecular weight by gel permeation chromatography (GPC; “Shodex GPC-101” manufactured by Showa Denko K.K.) using a polystyrene gel (“Shodex K-804” manufactured by Showa Denko K.K.) as a column and chloroform as a mobile phase.

The percentage of molecular weight retention after heating was calculated by the following equation.

$$Equation : Percentage of molecular weight retention after heating ( \% ) = weight - average molecular weight after heating / \\ weight - average molecular weight before heating \times 100$$

### [Percentage of Tearing Resistance Retention After Heating]

Each of the laminates obtained in Examples and Comparative Examples was evaluated for tearing resistance (tearing resistance after heating) according to JIS P 8116.

Additionally, for each of Examples and Comparative Examples, the laminate that was not yet heated using superheated steam or a hot air oven was also evaluated for tearing resistance (tearing resistance before heating).

The percentage of tearing resistance retention after heating was calculated by the following equation.

$$Equation : Percentage of tearing resistance retention after heating ( \% ) = tearing resistance after heating / tearing resistance before heating \times 100$$

### [Color Change]

The paper surface (the surface facing away from the resin layer) of each of the laminates obtained in Examples and Comparative Examples was visually inspected to determine whether or not the paper substrate was discolored (discoloration caused by heating).

TABLE 1

| | | Ex. 1 | Ex. 2 | Ex. 3 | Ex. 4 | Comp. 1 | Comp. 2 | Comp. 3 | Comp. 4 | Comp. 5 |
|---|---|---|---|---|---|---|---|---|---|---|
| Heating means | — | Superheated | Superheated | Superheated | Superheated | Superheated | Hot air | Hot air | Hot air | Hot air |
| | | steam | steam | steam | steam | steam | | | | |
| Coating surface | ° C. | Tm + 30 | Tm + 40 | Tm + 60 | Tm + 70 | Tm + 120 | Tm + 40 | Tm + 50 | Tm + 60 | Tm + 70 |
| temperature | | | | | | | | | | |
| Quality of | — | Good | Good | Good | Good | Good | Poor | Poor | Poor | Poor |
| particle fusion | | | | | | | | | | |
| Curl height | mm | 5 | 5 | 5 | 4 | 5 | 30 | 30 | 50 | 50 |
| Percentage of | % | 98 | 100 | 97 | 83 | 40 | 100 | 95 | 95 | 45 |
| molecular weight | | | | | | | | | | |
| retention after heating | | | | | | | | | | |
| Percentage of tear | % | 100 | 100 | 100 | 98 | 100 | 96 | 92 | 90 | 87 |
| resistance retention | | | | | | | | | | |
| after heating | | | | | | | | | | |
| Color change | — | Not | Not | Not | Not | Not | Slightly | Slightly | Slightly | Discolored |
| | | discolored | discolored | discolored | discolored | discolored | discolored | discolored | discolored | |

Table 1 reveals that in Examples 1 to 4, where the application of the aqueous resin dispersion was followed by using superheated steam to heat the coating to a temperature 10 to 100° C. above the resin melting point, any particulate portion or void was not found in the resin layer of the obtained laminate. This means that the resin was fully fused in Examples 1 to 4. Furthermore, the heating-induced loss in the molecular weight of the resin was small, as demonstrated by the relatively high percentage of molecular weight retention after heating.

In Comparative Example 1, where superheated steam was used but the heating temperature was set high, the heating caused a significant loss in the molecular weight of the resin, as demonstrated by the low percentage of molecular weight retention after heating.

In Comparative Examples 2 to 5, where the coating was heated using common hot air instead of superheated steam, a particulate portion or a void was found in the resin layer of the obtained laminate. That is, the resin was not fully fused and the resin layer lacked sufficient uniformity, despite the heating temperature being similar to that in Examples 1 to 4.

It is also seen that the defects attributable to the heating step, namely, curling, loss in tearing resistance, and discoloration of the paper substrate, were less severe in Examples 1 to 4 than in Comparative Examples 2 to 5.

1. A method for producing a laminate including a substrate and a resin layer formed on at least one side of the substrate, the method comprising:
forming a coating on the substrate by applying an aqueous dispersion of a poly(hydroxyalkanoate) resin to the substrate; and
forming the resin layer by fusing the poly(hydroxyalkanoate) resin through heating of the coating, wherein the coating is heated using superheated steam to a surface temperature 10 to 100° C. above a melting point Tm of the poly(hydroxyalkanoate) resin.

2. The method claim 1, wherein the substrate is paper.

3. The method of claim 1, wherein
an amount measured in a dry weight per square meter of the applied poly(hydroxyalkanoate) resin divided by a weight per square meter of the substrate (the amount of the applied poly(hydroxyalkanoate) resin/the weight per square meter of the substrate) is from 0.05 to 0.45.

4. The method of claim 1, wherein
the amount measured in the dry weight per square meter of the applied poly(hydroxyalkanoate) resin is from 1.0 to 80 g/m².

5. The method of claim 1, wherein
the weight per square meter of the substrate is from 40 to 400 g/m².

6. The method of claim 1, wherein
the poly(hydroxyalkanoate) resin is a poly(3-hydroxybutyrate) resin.

7. The method of claim 6, wherein
the poly(3-hydroxybutyrate) resin comprises a copolymer of 3-hydroxybutyrate units and units of at least one hydroxyalkanoate other than 3-hydroxybutyrate.

8. The method of claim 7, wherein
an average content of the 3-hydroxybutyrate units in the poly(3-hydroxybutyrate) resin is from 70 to 97 mol %.

9. The method claim 7, wherein
units of at least one hydroxyalkanoate other than 3-hydroxybutyrate are 3-hydroxyhexanoate units.

10. The method of claim 1, further comprising drying the coating by heating the coating at a temperature lower than the melting point Tm of the poly(hydroxyalkanoate) resin before the step of forming the resin layer.

11. The method of claim 10, further comprising adjusting a moisture content of the substrate before forming the resin layer and after drying the coating.

12. The method of claim 1, further comprising adjusting a moisture content of the substrate after forming the resin layer.

13. The method of claim 1, wherein
in a crystalline melting curve obtained by differential scanning calorimetry of the resin layer, the resin layer has at least one peak top temperature Tma in a range of 100 to 150° C. and at least one peak top temperature Tmb in a range of 150 to 170° C., and
a difference between the temperatures Tma and Tmb is 10° C. or more.

14. A method for producing a molded article, the method comprising:
producing a laminate by the method of claim 1; and
molding the laminate into the molded article.

15. The method of claim 14, wherein
the molded article is a packaging bag, a lidding material, or a container.
